(19) United States
(12) Patent Application Publication
(10) Pub. No.: US 2011/0247078 A1
(43) Pub. Date: Oct. 6, 2011

(54) INFORMATION PROCESSING APPARATUS

(75) Inventor: Kazuya FUKUSHIMA, Hamura-shi (JP)

(73) Assignee: KABUSHIKI KAISHA TOSHIBA, Tokyo (JP)

(21) Appl. No.: 13/077,732

(22) Filed: Mar. 31, 2011

(30) Foreign Application Priority Data
Mar. 31, 2010 (JP) 2010-084337

(51) Int. Cl. G06F 21/00

(52) U.S. Cl. 726/27

(57) ABSTRACT

According to one embodiment, an information processing apparatus is provided. The information processing apparatus includes: a body case;
a wireless communication module incorporated in the body case; a first storage module which stores first identification information that is acquired by communicating with an access point through the wireless communication module, the identification information indicating an attribute of a network area where the access point exists; a second storage module which stores second identification information that is used in each access point; and a security module which executes a function of limiting a use of the information processing apparatus when the acquired first identification information is changed from identification information stored in the first storage module.

### CROSS REFERENCE TO RELATED APPLICATION(S)

The application is based upon and claims the benefit of priority from Japanese Patent Application No. 2010-084337 filed on Mar. 31, 2010; the entire contents of which are incorporated herein by reference.

### FIELD

Embodiments described herein relate generally to security of an information processing apparatus.

### BACKGROUND

An information processing apparatus such as a portable communication terminal or a note-type personal computer is usually configured so as to be battery operable, and often used while being carried. There is a risk that an information processing apparatus may be taken out and used by a third party. Therefore, it is necessary to consider countermeasures for preventing an information processing apparatus from being stolen and unauthorizedly used after steal.

JP-A-2006-279770 discloses a portable communication terminal in which, each time when the terminal is moved from a service area of a base station into that of another base station, the presence or absence of a service stop request sent from the other base station is checked, and the function of the terminal itself is stopped in accordance with a result of the check.

There are various methods for enhancing the resistance against information leakage and unauthorized use due to steal of an information processing apparatus. However, it is preferable that a cost increase caused by improvement of the security resistance is suppressed as far as possible.

### BRIEF DESCRIPTION OF THE DRAWINGS

FIG. 1 is an external perspective view showing a computer of an embodiment.

FIG. 2 is a block diagram showing the configuration of the computer of the embodiment.

FIG. 3 is a view schematically showing a network in the embodiment.

FIG. 4 is a flowchart showing a security operation in the embodiment.

### DETAILED DESCRIPTION

In general, according to one embodiment, an information processing apparatus is provided. The information processing apparatus includes: a body case; a wireless communication module incorporated in the body case; a first storage module which stores first identification information that is acquired by communicating with an access point through the wireless communication module, the identification information indicating an attribute of a network area where the access point exists; a second storage module which stores second identification information that is used in each access point; and a security module which executes a function of limiting a use of the information processing apparatus when the acquired first identification information is changed from identification information stored in the first storage module.

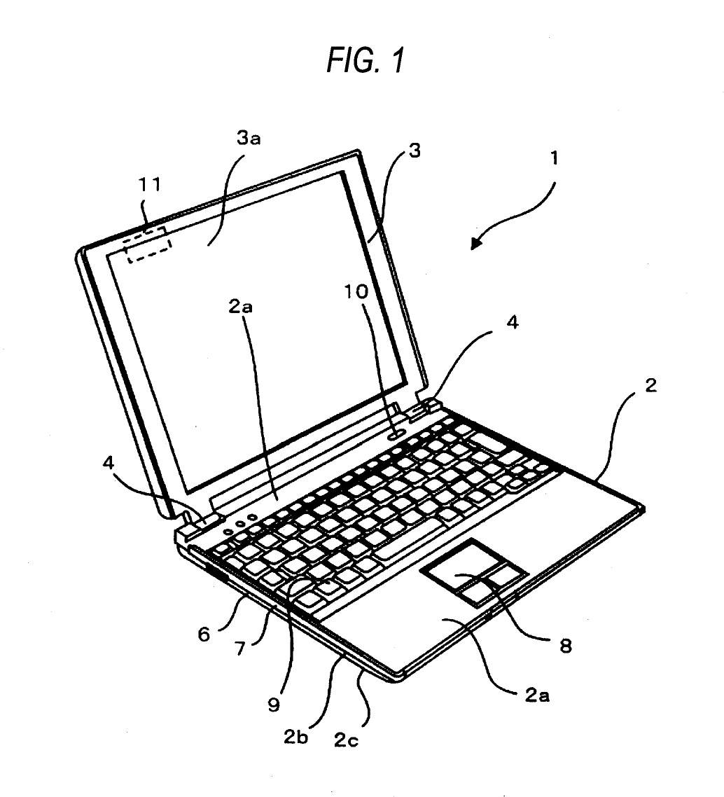

Hereinafter, an embodiment will be described with reference to FIGS. 1 to 4. The embodiment will be described by exemplifying a note-type personal computer as the information processing apparatus. FIG. 1 is an external perspective view showing the computer of the embodiment.

The computer 1 includes a body case 2 and a display case 3. The body case 2 is formed as a flat box-like shape having an upper wall 2a, right and left sidewalls 2b, and a bottom wall 2c. The upper wall 2a supports a keyboard 9.

The body case 2 is divided into a base 6 having the bottom wall 2c, and a top cover 7 having the upper wall 2a. The top cover 7 covers the base 6 from the upper side, and is detachably supported by the base 6.

The display case 3 is swingably attached to the body case 2 through a hinge portion 4. The display case 3 is swingable between an open position where the upper wall 2a of the body case 2 is opened, and a close position where the upper wall 2a of the body case 2 is covered by the display case 3. A display device configured by a Liquid Crystal Display (LCD) 3a is incorporated in the display case 3.

A touch pad 8 and keyboard 9 which are used by the user for performing an input operation are attached to the upper wall 2a of the body case 2. Also a power supply switch 10 for turning ON/OFF the power supply of the computer 1 is disposed in the upper wall 2a of the body case 2.

An antenna 11 for performing wireless communication is disposed in the display case 3. FIG. 1 shows an example in which one antenna 11 is disposed. Alternatively, a plurality of antennas may be disposed. Although the antenna 11 is disposed in an upper portion of the display case 3, the position where the antenna 11 is disposed is adequately adjusted in accordance with the space in the display case 3 and characteristics of the wireless communication.

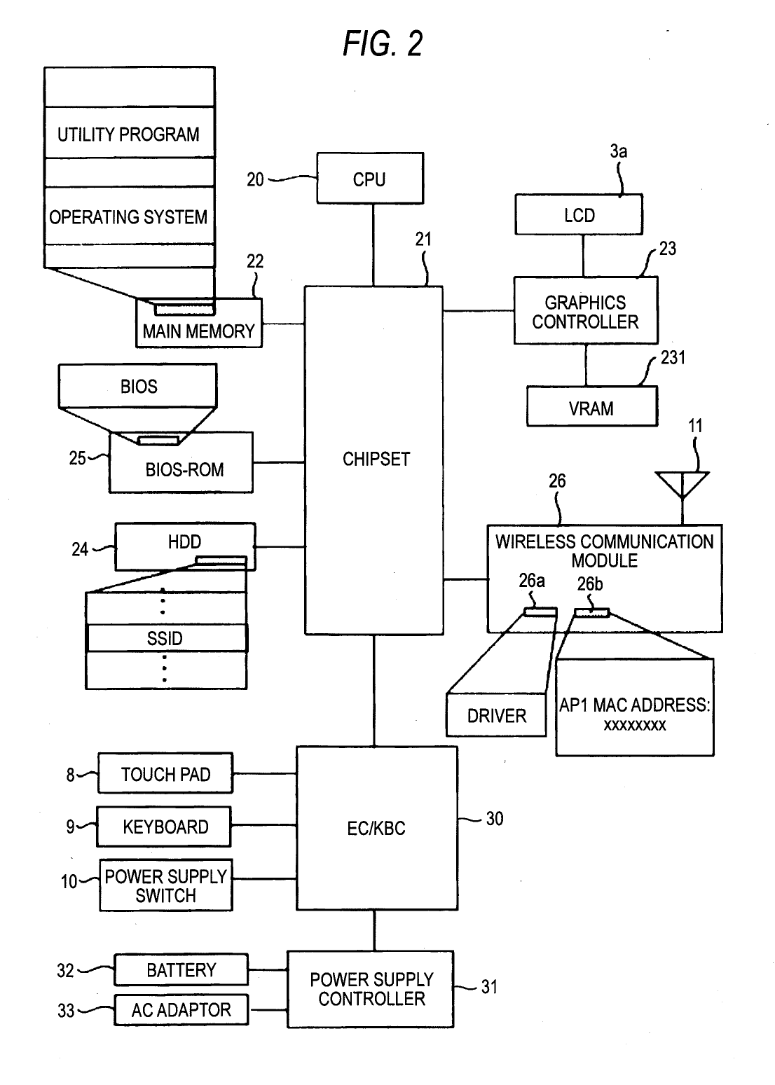

FIG. 2 is a block diagram showing the configuration of the computer of the embodiment. In the computer 1, disposed are a CPU 20, a chipset 21, a main memory (RAM) 22, a graphics controller 23, a hard disk drive (HDD) 24, a BIOS-ROM 25, an embedded controller/keyboard controller IC (EC/KBC) 30, the display device 3a, the touch pad 8, the keyboard 9, the power supply switch 10, etc.

The CPU 20 is a processor which controls the operations of the components of the computer 1. The CPU 20 executes the operating system and various application programs/utility programs which are loaded from the HDD 24 into the main memory (RAM) 22. The main memory (RAM) 22 is used also for storing various data buffers.

The CPU 20 also executes a Basic Input Output System (BIOS) stored in the BIOS-ROM 25. The BIOS is a program for controlling the hardware. The BIOS includes a group of BIOS drivers. In order to provide the operating system and the application programs with a plurality of functions for controlling the hardware, each BIOS driver includes a plurality of function execution routines corresponding to the functions.

The BIOS executes also a process of developing the operating system from a storage device such as the HDD 24 into the main memory (RAM) 22 to set the computer 1 to a state in which the user can operate the computer.

The chipset 21 includes interfaces with the CPU 20, the main memory (RAM) 22, and the graphics controller 23, and communicates with the embedded controller/keyboard controller 30.

The graphics controller 23 controls the LCD 3a which is used as a display monitor of the computer 1. The graphics controller 23 sends to the LCD 3a a video signal corresponding to display data which are written into a VRAM 231 by the OS or an application program.

The HDD 24 stores the OS, the various application programs/utility programs, and data file. Also a Service Set Identifier (SSID) is stored in the HDD 24. The SSID is an identifier for identifying an access point of a wireless LAN, and indicates the kind and attribute of a network. The same SSID indicates that access points exist in the identical network area. Namely, the access points belong to the identical domain. In other words, in the case where a plurality of access points provide connection to the identical network, the access points share the same SSID.

A Media Access Control (MAC) address is a physical address which is uniquely allocated to hardware of a network apparatus. Even when a plurality of access points belonging to the identical network share the same SSID, therefore, the MAC address differs depending on the access point.

A wireless communication module 26 is a module for controlling communication which is performed through the antenna 11. The wireless communication module 26 performs modulation, demodulation, and the like on data which are transmitted and received through the antenna 11. The wireless communication module 26 includes a first nonvolatile memory 26a and a second nonvolatile memory 26b. The first nonvolatile memory 26a stores a driver for controlling the operation of the wireless communication module 26. The second nonvolatile memory 26b stores a MAC address of an access point.

When the computer 1 communicates with an access point through the wireless communication module 26 and the antenna 11, the computer acquires an SSID from the access point by means of a driver. The acquired SSID is stored in the HDD 24.

The wireless communication module 26 performs processes of acquiring a MAC address from the access point, and storing the acquired MAC address in the second nonvolatile memory 26b. In the case where a new access point is found and a second MAC address is acquired, the module performs a process of comparing the first MAC address stored in the second nonvolatile memory 26b with the second MAC address. As required, the module performs a process of updating the MAC address stored in the second nonvolatile memory 26b with the second MAC address. A driver provided in the wireless communication module 26 is executed to perform these processes.

The MAC address acquired from an access point by wireless communication module 26 is stored in the second nonvolatile memory 26b. Alternatively, a MAC address acquired by the wireless communication module 26 may be stored in the HDD 24.

The EC/KBC 30 is a one-chip microcomputer on which a controller for managing the power supply to the computer 1, and a keyboard controller for controlling the touch pad 8, the keyboard 9, function buttons, and the like are integrated with each other.

The EC/KBC 30 cooperates with a power supply controller 31 to execute a process of powering ON/OFF the computer 1 in response to an operation which is performed by the user on the power supply switch 10. The power supply controller 31 supplies an electric power to the components of the computer 1 by using an electric power supplied from a battery 32 incorporated in the computer 1, or that which is externally supplied through an AC adaptor 33.

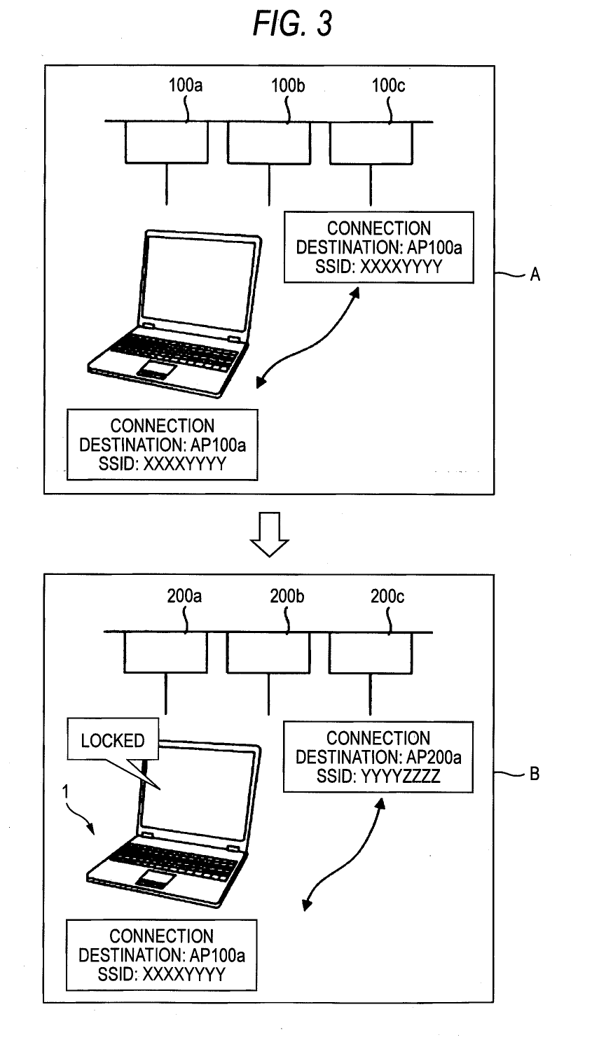

FIG. 3 is a view schematically showing a network in the embodiment.

An access point 100a, an access point 100b, and an access point 100c exist in a network area A. The access point 100a, the access point 100b, and the access point 100c have the same SSID. It is assumed that the SSID of the access point 100a, the access point 100b, and the access point 100c is “XXXXYYYY”.

By contrast, the access point 100a, the access point 100b, and the access point 100c have different MAC addresses, respectively.

An access point 200a, an access point 200b, and an access point 200c exist in a network area B. The access point 200a, the access point 200b, and the access point 200c have the same SSID. It is assumed that the SSID of the access point 200a, the access point 200b, and the access point 200c is “YYYYZZZZ”.

By contrast, the access point 200a, the access point 200b, and the access point 200c have different MAC addresses, respectively.

The case where the computer 1 which is positioned in the network area A is moved into the network area B will be considered. The computer 1 is set so as to perform wireless communication in the network area A, and to be used in the network area A. By contrast, the computer 1 is set so as not to be used in the network area B. Namely, the computer is set so as to be locked when the computer 1 is positioned in the network area B.

A network in which the computer 1 can be used is set by previously registering a reference SSID. The reference SSID is previously stored in the HDD 24 of the computer 1 or the like. FIG. 3 shows an example in which “XXXXYYYY” is stored in the HDD 24 as the reference SSID. In a network area having one or plural SSIDs which are determined in arbitrary units, such as units of rooms, buildings, or premises, the computer 1 is not locked. When the computer 1 is positioned in the network area A in which the SSID of the access point 100a is “XXXXYYYY”, namely, the lock does not function in the computer 1. By contrast, when the computer 1 is positioned in the network area B in which the SSID of the access point 200a is “YYYYZZZZ”, the security function operates in the computer 1 so that the computer is locked. When the computer 1 cannot see the predetermined SSID “XXXXYYYY”, the security function operates and the computer is locked. Examples of the security function are the following process: a process in which the computer 1 is locked and it is requested to input a password; that in which the computer 1 is forcibly shut down; and that in which the computer 1 is shut down and then disabled to be rebooted until the computer returns to a position in a network area where the computer is predetermined to be usable.

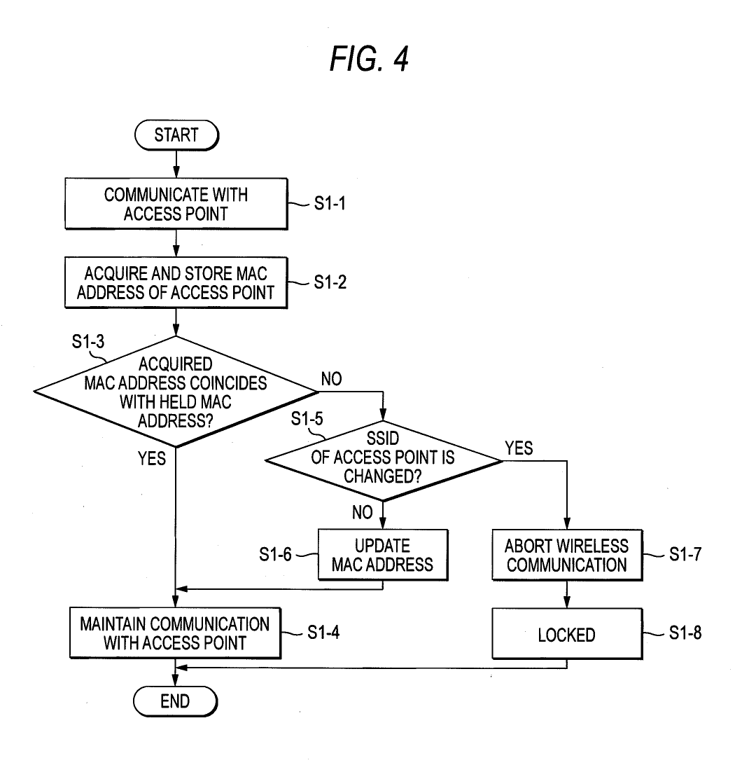

FIG. 4 is a flowchart showing the security operation in the embodiment.

The computer 1 communicates with an access point through the wireless communication module 26 and the antenna 11 (Step S1-1). The computer 1 acquires the MAC address of the access point through the wireless communication module 26, and stores the MAC address (Step S1-2).

Each time when communicating with an access point, the wireless communication module 26 compares the MAC address acquired from the access point with the MAC address stored in the HDD 24 (Step S1-3).

If the acquired MAC address coincides with the MAC address stored in the HDD 24 (Yes in Step S1-3), it is said that the access point with which the computer 1 communicates through the wireless communication module 26 is not changed. Therefore, the computer 1 maintains the communication with the access point (Step S1-4).

By contrast, if the acquired MAC address differs from the MAC address stored in the HDD 24 (No in Step S1-3), it is said that the access point with which the computer 1 communicates through the wireless communication module 26 is changed. In this case, then, it is checked whether the SSID of the access point is changed or not (Step S1-5). If the SSID of the access point with which the computer 1 communicates through the wireless communication module 26 is not changed (No in Step S1-5), the communication is maintained as it is (Step S1-4). At this time, the MAC address stored in the second nonvolatile memory 26b of the wireless communication module 26 is updated (Step S1-6). The situation in which the access point of the communication destination is changed but the SSID is not changed means that the network area is unchanged, and hence the computer 1 can continue to communicate with the access point.

If the SSID of the access point with which the computer 1 communicates through the wireless communication module 26 is changed (Yes in Step S1-5), the wireless communication module 26 aborts the wireless communication (Step S1-7). The situation in which the SSID of the access point with which the communication is performed is changed means that the network area where the computer 1 is positioned is changed. Consequently, there is the possibility that the computer 1 is stolen, and hence the security function is caused to operate, so that the computer 1 is locked (Step S1-8).

During a period when the connection with an access point having the SSID which is the same as the SSID that is preset in the computer 1 is continued, the computer 1 operates as usual. When the connection with the access point having the preset SSID is interrupted, the security function of the computer 1 is caused to operate, and the computer 1 is locked. Examples of the process of, after the computer 1 is locked, resetting the computer 1 to a state where it can be operated are a process of inputting a password which is previously registered, and that of moving the computer 1 to a position which is predetermined as a usable network area.

For each of network areas, a security range can be relatively easily set. The security function can be caused to operate by using an SSID and MAC address which are used in a usual wireless communication sequence between a computer and an access point.

As described above, the security function in the embodiment can be realized by changing a driver of the wireless communication module. According the embodiment, it is possible to provide an information processing apparatus in which the security resistance can be improved without addition of special hardware.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a body case;
a wireless communicator configured to be at least partially incorporated in the body case;
a first storage configured to store first identification information acquired from an access point through the wireless communicator, the first identification information indicative of an attribute of a network area of the access point;
a second storage configured to store second identification information that is used in each of one or more access points; and
a security module configured to limit a use of the information processing apparatus when acquired first identification information is different from the first identification information stored in the first storage.

2. The apparatus of claim 1, wherein the first storage is configured to store reference identification information that, among a plurality of sets of first identification information, functions as a reference designating in which network area the information processing apparatus is usable.

3. The apparatus of claim 2, wherein the security module is further configured to limit a use of the information processing apparatus when an access point is not within a communication range of the information processing apparatus.

4. The apparatus of claim 2, wherein the security module is further configured to limit a use of the information processing apparatus when an access point having the first identification information is not within a communication range of the information processing apparatus.

5. The apparatus of claim 2, wherein the security module is further configured to limit a use of the information processing apparatus when second identification information, acquired from an access point through the wireless communication module, is different from the second identification information stored in the second storage.

6. An electronic apparatus comprising:
a wireless receiver configured to receive a plurality of first identifications and a plurality of second identifications, wherein the first identifications have a first identification type, and the second identifications have a second identification type;
at least one memory configured to store at least one identification of the plurality of first identifications as a first stored identification, and to store at least one identification of the plurality of second identifications as a second stored identification; and
a security lock configured to at least partially restrict access to the electronic apparatus when the wireless receiver receives an identification having the first identification type and the received identification does not match the first stored identification.

7. A method of controlling access to an electronic apparatus comprising:
receiving a first identification having a first identification type;
storing the first identification in at least one memory as a first reference;
receiving a second identification having a second identification type;
storing the second identification in at least one memory as a second reference;
receiving a third identification having the first identification type;
receiving a fourth identification having the second identification type;
comparing the first and third identifications;
comparing the second and fourth identifications;
at least partially restricting access to the electronic apparatus when the third identification differs from the first reference and the fourth identification differs from the second reference.; and
overwriting the third identification in the at least one memory as the first reference when the third identification differs from the first reference and the fourth identification matches the second reference.
